(19) United States
(12) Patent Application Publication
(10) Pub. No.: US 2025/0313111 A1
(43) Pub. Date: Oct. 9, 2025

(54) CIRCUIT ARRANGEMENT FOR A CHARGING SYSTEM OF AN ELECTRICALLY OPERABLE VEHICLE

(71) Applicant: MERCEDES-BENZ GROUP AG, Stuttgart (DE)

(72) Inventors: Rushabh SHAH, Stuttgart (DE); Andreas TUTSCH, Waiblingen (DE)

(21) Appl. No.: 19/170,270

(22) Filed: Apr. 4, 2025

(30) Foreign Application Priority Data
Apr. 5, 2024 (DE) 10 2024 001 088.2

(51) Int. Cl. B60L 53/62; B60L 53/16; B60L 53/22; H01M 10/42; H02J 7/00

(52) U.S. Cl. CPC B60L 53/62; B60L 53/16; B60L 53/22; H02J 7/00712; H01M 10/425; H01M 2010/4271; H01M 2010/4278; H01M 2220/20

(57) ABSTRACT

A circuit arrangement for a charging system of an electrically operable vehicle includes a charging connection having a first input line and a second input line, which are electrically coupled to a high-voltage battery of the vehicle via charging contactors and via a current interruption device, and a voltage detection module electrically coupled to the first input line and the second input line and to the two charging contactors. The voltage detection module recognizes whether a direct voltage or an alternating voltage is present as the voltage type on the first input line and the second input line and to close the two charging contactors only if a direct voltage is present as the voltage type.

### CROSS-REFERENCE TO RELATED APPLICATIONS

This application claims priority under 35 U.S.C. § 119 to German patent application 10 2024 001 088.2, filed Apr. 5, 2024, the entire content of which is herein expressly incorporated by reference.

### BACKGROUND AND SUMMARY OF THE INVENTION

Exemplary embodiments of the invention relate to a circuit arrangement for a charging system of an electrically operable vehicle.

A charging connection of an electrically operable vehicle according to the NACS (North American Charging Standard) applicable in North America enables both direct current charging and alternating current charging. It is essential that the voltage type provided by the charging station and applied to the plug (DC or AC voltage assignment) matches the vehicle configuration required for this. The NACS standard requires DC charging contactors to be closed in accordance with the highest safety classification ASIL D (ASIL=Automotive Safety Integrity Level according to the ISO 26262:2018 Standard).

A circuit arrangement for a charging system of an electrically operable vehicle is known from DE 10 2017 011 857 A1, comprising a charging connection having a first input line and a second input line, which can be electrically coupled to a high-voltage battery of the vehicle via charging contactors and via a current interruption device of the circuit arrangement.

Exemplary embodiments of the invention are directed to a circuit arrangement for a charging system of an electrically operable vehicle which meets

According to one aspect of the invention, a circuit arrangement for a charging system of an electrically operable vehicle is proposed, at least comprising a charging connection having a first input line and a second input line, which can be electrically coupled or are coupled to a high-voltage battery of the vehicle via charging contactors of the circuit arrangement and via a current interruption device of the circuit arrangement, and a voltage detection module, which is electrically coupled to the first input line and the second input line and to the two charging contactors. The voltage detection module is designed to recognize whether a DC voltage or an AC voltage is present as the voltage type on the first input line and the second input line and to close the two charging contactors only if a DC voltage is present as the voltage type.

The requirements of the NACS standard for charging systems can be advantageously realized with the proposed circuit arrangement.

The voltage type (AC voltage or DC voltage) is recognized via the voltage detection module of the circuit arrangement and the DC voltage charging contactors are controlled by redirecting a set signal path via the voltage detection module. This means that existing charging contactors can be used without increasing the safety integrity.

In the circuit variants used until now, the voltage detection module can only determine the level of voltage applied and transmit this to a battery control unit. In these variants, the voltage type is recognized and the DC charging contactors are activated directly by means of the voltage detection module.

The circuit arrangement is advantageously set up to ensure that the two charging contactors are only closed by means of the voltage detection module when a DC voltage is detected by the voltage detection module. This is done via two independent lines and two independent charging contactors, each of which is qualified according to the ASIL B standard, which means that the ASIL D standard is met in this case.

This advantageously results in savings in development costs, development effort, and development time for the realization of a charging system for the NACS standard.

According to an advantageous embodiment, the circuit arrangement can further comprise a battery control unit, which is electrically coupled at least to the voltage detection module and the current interruption device. The battery control unit can communicate a request to open or close the two DC charging contactors to the voltage detection module, in particular to start DC charging, which then opens or closes the corresponding charging contactors accordingly. The two charging contactors are opened or closed by means of the voltage detection module.

According to an advantageous configuration of the circuit arrangement, the voltage detection module can be designed to communicate the voltage type to the battery control unit. By way of example, if an AC voltage is present, the battery control unit can initiate the charging process via the onboard charger.

According to an advantageous configuration of the circuit arrangement, the battery control unit can be designed to communicate a request to open or close the two charging contactors to the voltage detection module. In particular, the battery control unit can be designed to communicate a request to start a charging process to the voltage detection module when the DC voltage type is present. The battery control unit can thus communicate a request to open or close the two DC charging contactors to the voltage detection module, in particular to start DC charging, which then opens or closes the corresponding charging contactors accordingly. The two charging contactors are opened or closed by means of the voltage detection module.

According to an advantageous configuration of the circuit arrangement, the voltage detection module can be designed to forward a request from the battery control unit to open the two charging contactors to the two charging contactors. The two charging contactors can thus be opened in accordance with the ASIL B standard.

According to an advantageous configuration of the circuit arrangement, the battery control unit can have an onboard diagnostic unit, which is designed to receive diagnostic data from the voltage detection module and the two charging contactors. In this way, the voltage detection module and the two charging contactors can be monitored in a favorable manner and recorded centrally.

According to an advantageous configuration of the circuit arrangement, the battery control unit can be designed to control the current interruption device, in particular to open and close the current interruption device. This allows the current interruption device to be controlled by the battery control unit with the main contactors of the high-voltage battery.

According to an advantageous configuration of the circuit arrangement, the charging connection can be designed to recognize whether a DC charging plug or an AC charging plug is plugged in. The charging plug detection of the charging connection is advantageously part of the safety function of the switch arrangement.

According to an advantageous configuration, the circuit arrangement can be designed to keep the two charging contactors open when an AC voltage is applied to the charging connection or an AC charging plug is plugged into the charging connection, or no charging plug is plugged into the charging connection, or a charging plug is plugged in and no DC voltage is applied to the charging connection. In this way, the safety function of the circuit arrangement can be advantageously guaranteed.

According to an advantageous configuration, the circuit arrangement can further comprise an onboard charger, which is electrically coupled at least to the first input line and the second input line and to the current interruption device. The onboard charger can be activated to charge the high-voltage battery when an AC charging plug is plugged into the charging connection and an AC voltage is applied to the charging connection. The onboard charger can thus fulfil its charging function if an AC voltage is present.

Further advantages emerge from the following description of the drawing. An exemplary embodiment of the invention is depicted in the drawings. The drawing, the description and the claims comprise numerous features in combination. A person skilled in the art will also usefully consider the features individually and combine them into useful further combinations.

### BRIEF DESCRIPTION OF THE SOLE DRAWING FIGURE

The sole drawing figure illustrates a system overview of a circuit arrangement for a charging system of an electrically operable vehicle according to an exemplary embodiment of the invention.

The figure merely shows an example and is not to be understood as restrictive.

### DETAILED DESCRIPTION

The sole drawing figure shows a system overview of a circuit arrangement 100 for a charging system of an electrically operable vehicle according to an exemplary embodiment of the invention.

The circuit arrangement 100 comprises a charging connection 10 having a first input line 12 and a second input line 14, which are electrically coupled to a high-voltage battery 30 of the vehicle via DC charging contactors 16, 18 and via a current interruption device 20.

Furthermore, the circuit arrangement 100 comprises a voltage detection module 40, which is electrically coupled to the first input line 12 and the second input line 14 via the lines 42, 44 and to the two charging contactors 16, 18 via the lines 46, 48.

The voltage detection module 40 can recognize whether a DC voltage or an AC voltage is present as the voltage type on the first input line 12 and the second input line 14 and can only close the two charging contactors 16, 18 if a DC voltage is present as the voltage type.

The circuit arrangement further comprises a battery control unit 50, which is electrically coupled to the voltage detection module 40 via the lines 52, 54 and to the current interruption device 20 via the line 22.

The battery control unit 50 can control the current interruption device 20, in particular open and close the current interruption device 20. The current interruption device 20 comprises the main contactors of the high-voltage battery 30.

The battery control unit 50 further has an onboard diagnostic unit 80 which can receive diagnostic data from the voltage detection module 40 via the lines 52, 54 and diagnostic data from the two charging contactors 16, 18 via the lines 56, 58.

The voltage detection module 40 can communicate the voltage type to the battery control unit 50. The battery control unit 50 can in turn communicate a request to open or close the two charging contactors 16, 18 to the voltage detection module 40. In particular, the battery control unit 50 can communicate a request to start a charging process to the voltage detection module 40 when the DC voltage type is present. The voltage detection module 40 only closes the two charging contactors 16, 18 if a DC voltage is present as the voltage type.

A request from the battery control unit 50 to open the two charging contactors 16, 18, on the other hand, is simply passed on from the voltage detection module 40 to the two charging contactors 16, 18.

The charging connection 10 can favorably detect whether a DC charging plug or an AC charging plug is plugged in.

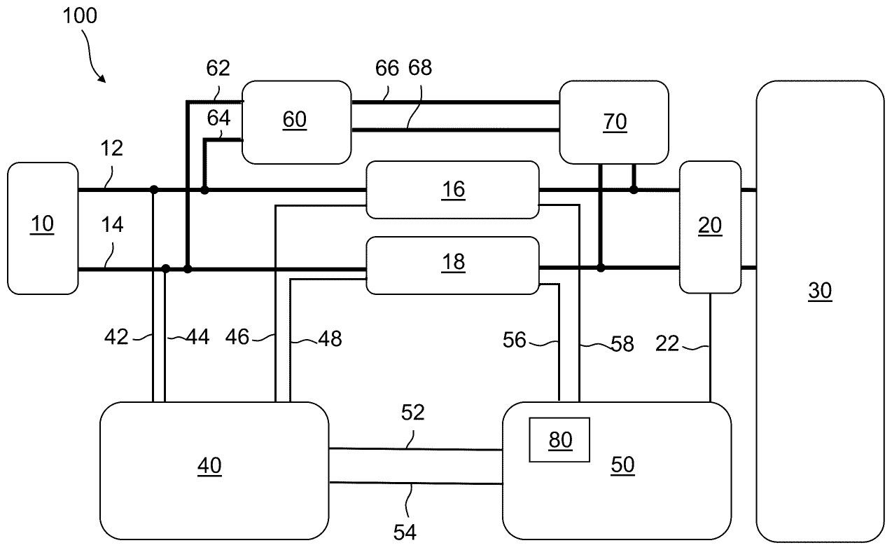

The circuit arrangement 100 depicted in FIG. 1 further comprises an onboard charger 60 whose AC voltage input is electrically coupled to the first input line 12 and the second input line 14 via the lines 62, 64 and whose DC voltage output is electrically coupled to the current interruption device 20 via the lines 66, 68 and the peripheral device 70. The onboard charger 60 is activated to charge the high-voltage battery 30 when an AC charging plug is plugged into the charging connection 10 and an AC voltage is applied to the charging connection 10.

By means of the proposed circuit arrangement 100, it can thus be advantageously ensured that the two charging contactors 16, 18 are not closed, i.e., that no electrical connection between the charging connection and the high-voltage battery is possible when an AC voltage is applied to the charging connection 10 or an AC voltage charging plug is plugged into the charging connection 10. The AC path is then activated via the onboard charger 60.

Furthermore, the two charging contactors are favorably not closed if no charging plug is plugged into the charging connection 10, or if a charging plug is plugged in and no DC voltage is present at the charging connection 10.

Advantageously, the proposed circuit arrangement 100 can be used to secure the following scenarios with the specified safety standards.

The following safety objectives can thus be achieved:

The DC charging contactors 16, 18 must not be closed when an AC voltage is present. This corresponds to the ASIL D standard.

The DC charging contactors 16, 18 must not be closed if no DC voltage is present. This corresponds to the ASIL B standard.

The AC voltage path must not be closed via the current interruption device 20 if no charging plug is plugged in. This corresponds to the ASIL B standard.

The AC voltage path must not be closed if a DC voltage is present. This corresponds to a normal safety standard.

The following functional safety requirements can be derived from this:

A voltage type, AC voltage or DC voltage, is recognized, which corresponds to an ASIL D standard.

It is avoided that the DC charging contactors 16, 18 are closed if no DC voltage is present. This corresponds to the ASIL D standard.

The DC charging contactors 16, 18 are open if no charging plug is plugged in. This corresponds to the ASIL B standard.

The AC voltage path is prevented from being closed via the current interruption device 20 if no charging plug is plugged in. This corresponds to the ASIL B standard.

The voltage detection module 40 meets the ASIL C standard. The battery control unit 50 meets the ASIL C standard. The charging connection meets the ASIL B standard. The onboard charger 60 meets the ASIL B standard.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

Reference numeral list

10 CHARGING CONNECTION

12 first input line

14 second input line

16 charging contactor

18 charging contactor

20 current interruption device

22 line

30 high-voltage battery

40 voltage detection module

42 line

44 line

46 line

48 line

50 battery control unit

52 line

54 line

56 line

58 line

60 onboard charger

62 line

64 line

66 line

68 line

70 peripheral device

80 onboard diagnostic unit

100 circuit arrangement

What is claimed is:

1. A circuit arrangement for a charging system of an electrically operable vehicle, the circuit arrangement comprising:
a current interruption device;
a charging connection having a first input line and a second input line, wherein the first and second input lines are electrically couplable to a high-voltage battery of the electrically operable vehicle via respective first and second charging contactors and via the current interruption device; and
a voltage detection module electrically coupled to the first input line, the second input line, the first charging contactor, and the second charging contactor,
wherein the voltage detection module is configured to determine whether a direct voltage or an alternating voltage is present as a voltage type on the first input line and the second input line and to close the first and second charging contactors only if a direct voltage is present as the voltage type.

2. The circuit arrangement of claim 1, further comprising:
a battery control unit electrically coupled at least to the voltage detection module and the current interruption device.

3. The circuit arrangement of claim 2, wherein the voltage detection module is configured to communicate the voltage type to the battery control unit.

4. The circuit arrangement of claim 2, wherein the battery control unit is configured to communicate a request to open or close the first and second charging contactors to the voltage detection module, and wherein the battery control unit is configured to communicate a request to start a charging process to the voltage detection module when a DC voltage type is present.

5. The circuit arrangement of claim 2, wherein the voltage detection module is configured to forward a request from the battery control unit to open the first and second charging contactors to the first and second charging contactors.

6. The circuit arrangement of claim 2, wherein the battery control unit has an onboard diagnostic unit configured to receive diagnostic data from the voltage detection module and the first and second charging contactors.

7. The circuit arrangement of claim 2, wherein the battery control unit is configured to control the current interruption device to open and close.

8. The circuit arrangement of claim 1, wherein the charging connection is configured to recognize whether a DC charging plug or an AC charging plug is plugged in.

9. The circuit arrangement of claim 8, wherein the circuit arrangement is configured to keep the first and second charging contactors open when
an AC voltage is applied to the charging connection or an AC charging plug is plugged into the charging connection,
no charging plug is plugged into the charging connection, or
a charging plug is plugged in and no DC voltage is present at the charging connection.

10. The circuit arrangement of claim 1, further comprising:
an onboard charger electrically coupled at least to the first input line and the second input line and to the current interruption device,
wherein the onboard charger is configured to charge the high-voltage battery and the onboard charger is activated when an AC charging plug is plugged into the charging connection and an AC voltage is applied to the charging connection.
